(19) United States
(12) Patent Application Publication
(10) Pub. No.: US 2006/0207175 A1
(43) Pub. Date: Sep. 21, 2006

(54) Flowerpot

(76) Inventor: Shi Fu Wu, I-Lan Hsien (TW)

Correspondence Address: TROXELL LAW OFFICE PLLC, SUITE 1404, 5205 LEESBURG PIKE, FALLS CHURCH, VA, 22041, US

(21) Appl. No.: 11/082,813

(22) Filed: Mar. 18, 2005

(51) Int. Cl. A01G 25/00

(52) U.S. Cl. 47/79

(57) ABSTRACT

A flowerpot comprising a main pot and a water receiving pot, the main pot has an opening for planting plant therein, and has on its bottom a plurality of holes. The water receiving pot is provided for receiving the main pot, a receiving space is formed between the bottom of the main pot and the water receiving pot to receive water. The water receiving pot has a liquid level indicating mark and at least a hole for pouring and discharging water on the outer surface of the pot; the hole is set higher than the liquid level indicating mark. The root of the plant in the main pot can absorb the water vapor evaporated from the water receiving pot through the holes on the bottom of the main pot.

### BACKGROUND OF THE INVENTION

1. Field of the invention

The present invention relates to a flowerpot, more particularly to a flowerpot having a water receiving pot with a liquid level indicating mark and a hole on the outer surface of the water receiving pot, redundant water filled in the water receiving pot thus can spill over and flow out from the hole, the plant in a main pot can absorb the water vapor evaporated from the water receiving pot. The flowerpot is simple in structure and convenient for use; it can be applicable to flowerpots for planting various plants and flowers etc.

2. Description of the Prior Art

Life nowadays is busy and people living in cities devote themselves to works day by day; lives thus become relatively dull. Alternatively, more and more people tend to plant pot plants to make green of their environments for pot plants not only having a function of beautifying environments, but also bringing fresh air, and easing the nervous minds of modern people.

A conventional flowerpot with plant can have therein culture soil and plant, and has on its bottom a plurality of water discharging holes, so that when the culture soil in the pot contains too much water, the water can be discharged out of the discharging holes. However, the way of providing discharging holes on the bottom of the flowerpot is unable to render the soil in the flowerpot to contain sufficient water, hence the flowerpot must be watered timely to avoid fading of the plant.

In view of the flaw, a disk with a plain bottom has been designed be padded on the bottom of a flowerpot to store the water discharged from the water discharging holes. However, because the bottom of the flowerpot is put directly on the disk with the plain bottom and is immerged in water, the root of the plant in the pot thus is subject to be corrupted. This is an undesired design.

### SUMMARY OF THE INVENTION

The main objective of the present invention is to provide a flowerpot which is in simple structure and convenient for a user to take care of pot plant; the water receiving pot has a liquid level indicating mark and a hole on its outer surface, redundant water filled in the pot thus can flow out from the hole, and the plant in a main pot can absorb the water vapor evaporated from the pot.

To achieve the above stated objective, the flowerpot of the present invention comprises a main pot and a water receiving pot. The main pot has an opening for planting plant therein, and has on its bottom a plurality of holes; the water receiving pot is provided for receiving the main pot, a suitable receiving space is formed between the bottom of the main pot and the water receiving pot to receive water, the water receiving pot has a liquid level indicating mark and at least a hole for pouring and discharging water on the outer surface of the water receiving pot, the hole is set higher than the liquid level indicating mark.

Thereby, redundant water filled in the water receiving pot can spill over the hole and flow out; the root of the plant in the main pot can absorb the water vapor evaporated from the water receiving pot rather than contact directly with water in the receiving pot. After a period of time of growing, the root extends into the water and is not subject to being corrupted by immerging in the water.

The present invention will be apparent after reading the detailed description of the preferred embodiment thereof in reference to the accompanying drawings.

### BRIEF DESCRIPTION OF THE DRAWINGS

FIG. 1 is an exploded view showing the appearance of an embodiment of the present invention;

FIG. 2 is a perspective view showing the appearance of the embodiment of the present invention after combination;

FIG. 3 is a schematic perspective view showing use of the embodiment of the present invention;

FIG. 4 is a schematic sectional view showing use of the embodiment of the present invention;

FIG. 5 is a schematic perspective view showing another state of combination of a main pot with a water receiving pot of the embodiment of the present invention; and

FIG. 6 is a perspective view showing the appearance of another embodiment of the present invention;

### DETAILED DESCRIPTION OF THE PREFERRED EMBODIMENT

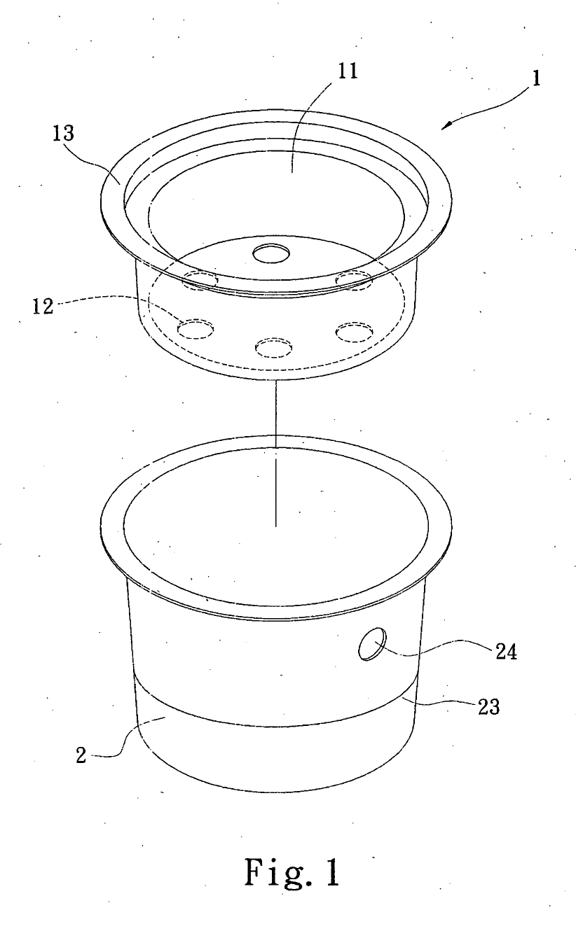

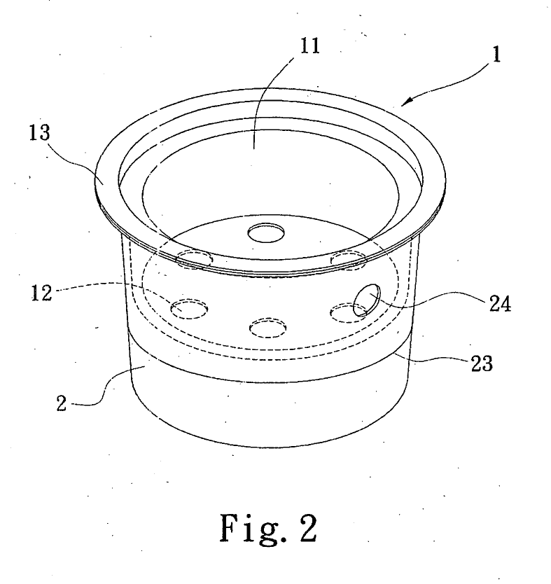

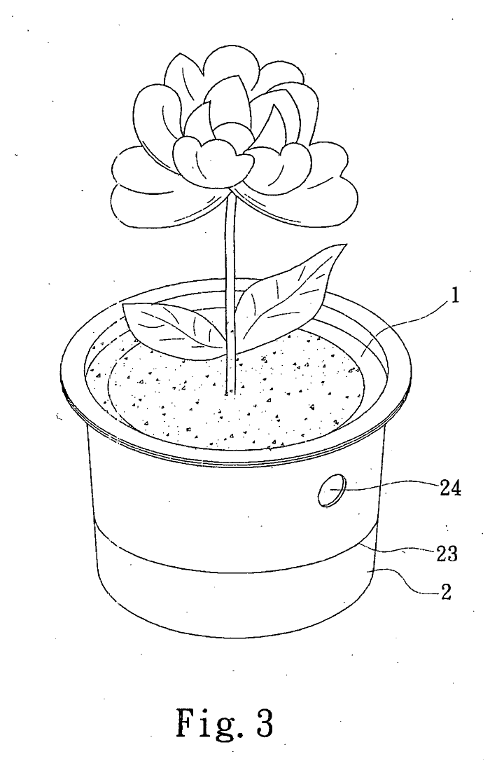

Referring to FIGS. 1-4 showing an embodiment of a flowerpot of the present invention, the embodiment comprises a main pot 1 and a water receiving pot 2.

The main pot 1 has an opening 11 for planting plant therein, and has on its bottom a plurality of holes 12. The opening 11 of the main pot 1 has a lip 13 turning over outwards, so that the main pot 1 can be received in the water receiving pot 2, the lip 13 can be abutted on the top of the water receiving pot 2 to form a receiving space 22 between the bottom of the main pot 1 and the water receiving pot 2 to receive water 3. The water receiving pot 2 has a liquid level indicating mark 23 and at least a hole 24 for pouring and discharging water on the outer surface of the water receiving pot 2. The liquid level indicating mark 23 circles the outer surface of the water receiving pot 2, the hole 24 is set higher than the liquid level indicating mark 23, thus redundant water filled in the water receiving pot 2 can spill over the hole 24 and flow out. The root of the plant in the main pot 1 can absorb the water vapor evaporated from the water receiving pot 2.

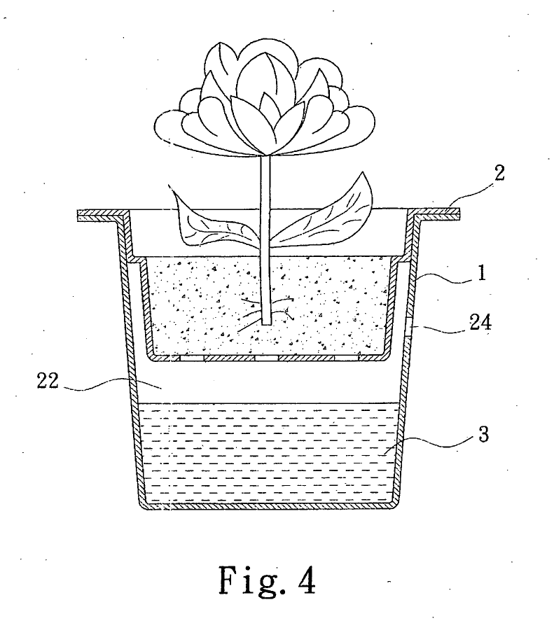

When in practicing, referring to FIG. 4, firstly, a user places a kind of pot plant in the main pot 1, or the plant can be directly planted in the main pot 1, then the water 3 is poured into the water receiving pot 2; when the level of the water 3 poured in exceeds the liquid level indicating mark 23 of the water receiving pot 2, redundant amount of the water 3 filled in the water receiving pot 2 thus can spill over the hole 24 and flow out. And the main pot 1 is placed into the water receiving pot 2, now that the hole 24 is lower than the bottom of the main pot 1 placed in the water receiving pot 2, the bottom of the main pot 1 has a distance from the water level in the water receiving pot 2, thereby the root of the plant in the main pot 1 can absorb the water vapor evaporated from the water receiving pot 2 at the initial stage of growth, when the plant grows up, the root can extend through the holes 12 on the bottom of the main pot 1 and into the water to absorb the water, such root having grown up will not corrupt while being immerging in the water.

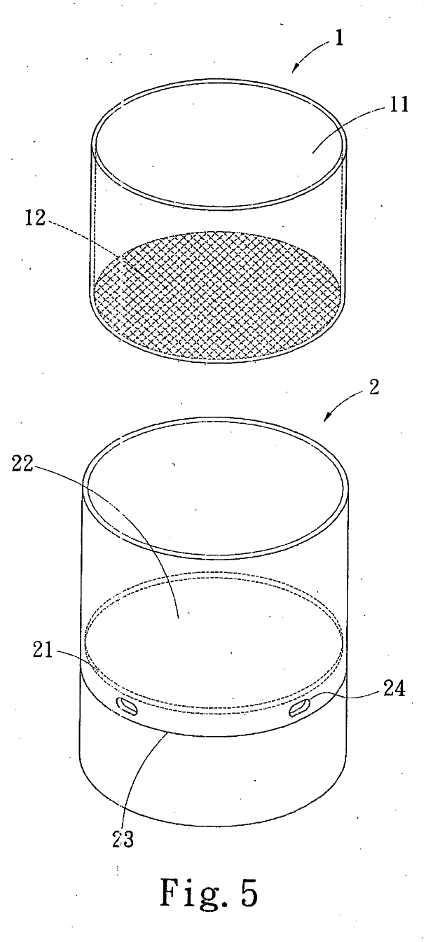

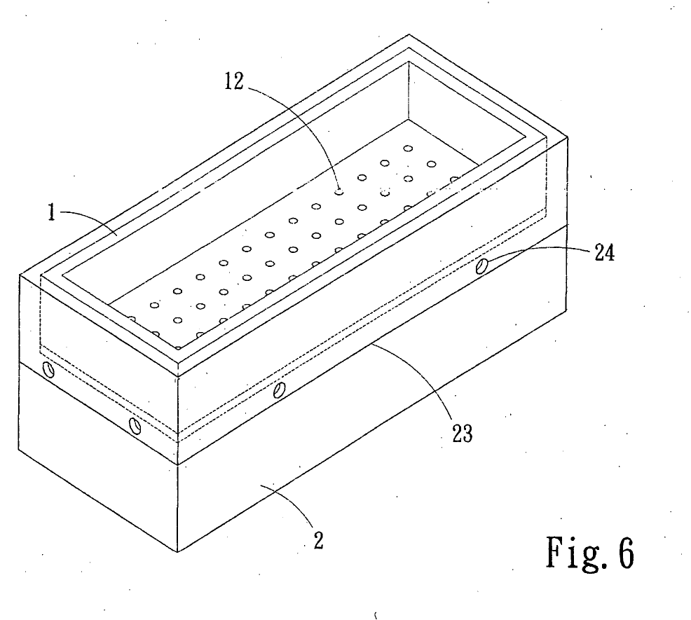

Moreover, the way of engagement of the main pot 1 with the water receiving pot 2 can be variant; such as shown in FIG. 5, the main pot 1 has an opening 11 for planting plant therein and has on a netted bottom with a plurality of holes 12. The water receiving pot 2 and the main pot 1 can be slipped one in the other, thereby the main pot 1 is received in the water receiving pot 2 which is made of transparent material and is provided with a supporting member 21 to firmly support the main pot 1 received in the water receiving pot 2. This can similarly have the effect of lapping and firmly receiving the main pot 1 over/in the water receiving pot 2. The appearances of the main pot 1 and the water receiving pot 2 are also variant by modeling for users' choices; such as shown in FIG. 6, the main pot 1 and the water receiving pot 2 can be rectangular, so that they can be placed outdoors after combination for making a scene or making the environment green.

Accordingly, the present invention has the following advantages:
1. In using the present invention, water is in the first place poured into the water receiving pot, if it exceeds the liquid level indicating mark of the water receiving pot, redundant amount of the water filled in can spill over the hole and flow out. Because the hole is set lower than the bottom of the main pot when being placed in the water receiving pot, the bottom of the main pot thus has a distance from the water level in the water receiving pot, thereby the problem that the root of the plant to be possibly corrupted as being immerged in the water can be avoided.
2. Further, because the bottom of the main pot is kept a distance from the water level in the water receiving pot after it is placed in, the root of the plant in the main pot can absorb the water vapor evaporated from the water receiving pot, a user can directly observe whether the water receiving pot has therein sufficient water and needs to be supplied with water timely or not.

In conclusion, the present invention surely can achieve the expected objective thereof to provide a flowerpot.

What is claimed is:

1. A flowerpot, comprising
a main pot for planting plant therein, said main pot has on its bottom a plurality of holes, and has an opening with a lip turning over outwards; and
a water receiving pot with a volume larger than that of said main pot to receive said main pot therein, said lip is adapted to abutting on a top of said water receiving pot to form a receiving space between said bottom of said main pot and said water receiving pot to receive water, said water receiving pot has at least a hole for pouring and discharging water on an outer surface of said water receiving pot;
thereby root of said plant in said main pot absorb water vapor evaporated from said water receiving pot through said holes on said bottom of said main pot.

2. The flowerpot as claimed in claim 1, wherein said water receiving pot has on said outer surface thereof a liquid level indicating mark.

3. The flowerpot as claimed in claim 1, wherein said main pot and said water receiving pot are slipped one in the other.

4. The flowerpot as claimed in claim 1, wherein said main pot and said water receiving pot are transparent.

5. The flowerpot as claimed in claim 1, wherein said main pot has on a netted bottom thereof a plurality of holes.

6. A flowerpot, comprising
a main pot for planting plant therein, said main pot has on its bottom a plurality of holes; and
a water receiving pot with a volume larger than that of said main pot to receive said main pot therein, said water receiving pot is provided with a supporting member to firmly support said main pot received in said water receiving pot to form a receiving space between said bottom of said main pot and said water receiving pot to receive water, said water receiving pot has at least a hole for pouring and discharging water on an outer surface thereof;
thereby root of said plant in said main pot absorb water vapor evaporated from said water receiving pot through said holes on said bottom of said main pot.
